(19) United States
(12) Patent Application Publication
(10) Pub. No.: US 2018/0232401 A1
(43) Pub. Date: Aug. 16, 2018

(54) INFORMATION PROCESSING APPARATUS AND NON-TRANSITORY COMPUTER READABLE RECORDING MEDIUM

(71) Applicant: FUJI XEROX CO., LTD., Tokyo (JP)

(72) Inventor: Ryouji TAGUCHI, Yokohama-shi (JP)

(73) Assignee: FUJI XEROX CO., LTD., Tokyo (JP)

(21) Appl. No.: 15/710,295

(22) Filed: Sep. 20, 2017

(30) Foreign Application Priority Data
Feb. 14, 2017 (JP) 2017-024713

(51) Int. Cl. G06F 17/30

(52) U.S. Cl. CPC G06F 17/30289

(57) ABSTRACT

An information processing apparatus includes a receiving unit that receives an operation request for an object, and a permitting unit that applies an operation executing condition to the object for which the operation request has been made to determine whether to permit an operation on the object, the operation executing condition including at least a condition determined by a relation between an object and another object within an object group in which the object is included.

### CROSS-REFERENCE TO RELATED APPLICATIONS

This application is based on and claims priority under 35 USC 119 from Japanese Parent Application No. 2017-024713 filed Feb. 14, 2017.

### BACKGROUND

### Technical Field

The present invention relates to an information processing apparatus and a non-transitory computer readable recording medium.

### SUMMARY

According to an aspect of the present invention, there is provided an information processing apparatus including a receiving unit that receives an operation request for an object, and a permitting unit that applies an operation executing condition to the object for which the operation request has been made to determine whether to permit an operation on the object, the operation executing condition including at least a condition determined by a relation between an object and another object within an object group in which the object is included.

### BRIEF DESCRIPTION OF THE DRAWINGS

Exemplary embodiment of the present invention will be described in detail based on the following figures, wherein:

FIG. 1 is a conceptual module diagram of an exemplary configuration according to the exemplary embodiment;

FIG. 2 illustrates an exemplary system configuration according to the exemplary embodiment;

FIG. 3 illustrates exemplary information shown on a task list screen according to the exemplary embodiment;

FIG. 4 illustrates exemplary information shown on a task edit screen according to the exemplary embodiment;

FIG. 5 illustrates an exemplary data structure of a document configuration information table;

FIG. 6 illustrates an exemplary data structure of a process configuration information table;

FIG. 7 illustrates an exemplary data structure of a process information table;

FIG. 8 illustrates an exemplary data structure of a document information table;

FIG. 9 illustrates an exemplary data structure of a user information table;

FIG. 10 illustrates exemplary information shown on a document-group operation authority setting screen according to the exemplary embodiment;

FIG. 11 illustrates an exemplary data structure of an operation authority table;

FIG. 12 illustrates exemplary information shown on a “Quotation” list screen according to the exemplary embodiment;

FIG. 13 is a flowchart of exemplary processing according to the exemplary embodiment;

FIG. 14 is a flowchart of exemplary processing according to the exemplary embodiment;

FIG. 15 is a flowchart of exemplary processing according to the exemplary embodiment; and

FIG. 16 is a block diagram illustrating an exemplary hardware configuration of a computer that implements the exemplary embodiment.

### DETAILED DESCRIPTION

An exemplary embodiment of the present invention will be described below with reference to the drawings.

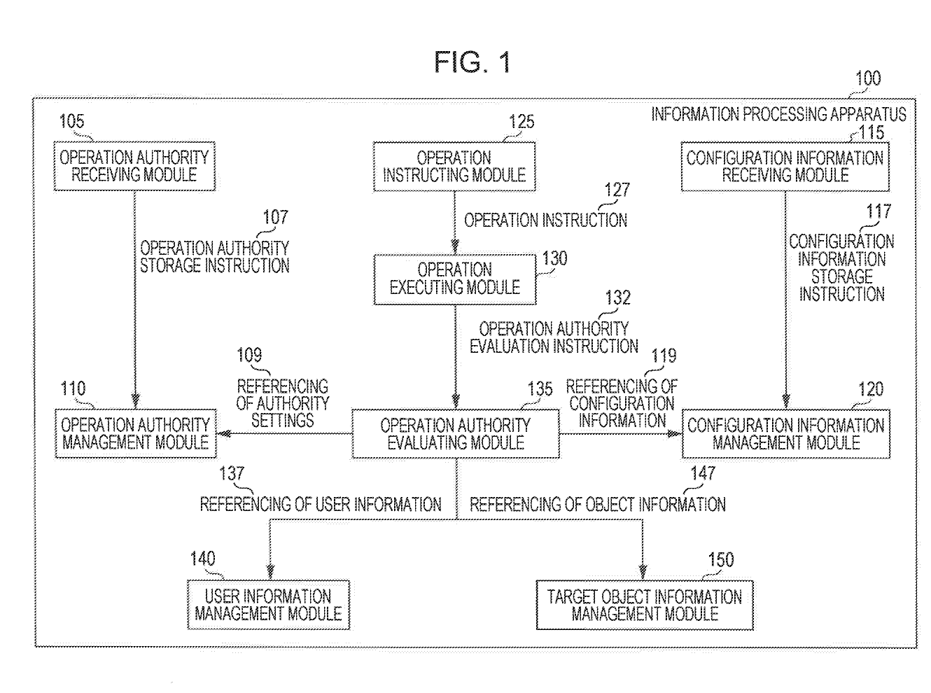

FIG. 1 is a conceptual module diagram of an exemplary configuration according to the exemplary embodiment.

The term “module” generally refers to a logically separable component such as software (computer program) or hardware. Accordingly, the term “module” as used in the exemplary embodiment refers to not only a module in a computer program but also a module in a hardware configuration. Therefore, the exemplary embodiment will be also described also in the context of a computer program for providing functions of such modules (a program for causing a computer to execute individual procedures, a program for causing a computer to function as individual units, or a program for causing a computer to implement individual functions), a system, and a method. Although “store”, “be stored”, and equivalent expressions are used herein for the convenience of description, these expressions mean, when an exemplary embodiment relates to a computer program, “cause a memory to store” or “control a memory so as to store”. Although individual modules and functions may have a one-to-one correspondence, in actual implementation, a single module may be implemented by a single program, or multiple modules may be implemented by a single program. Conversely, a single module may be implemented by multiple programs. Further, multiple modules may be executed by a single computer, or a single module may be executed by multiple computers that are in a distributed or parallel environment. A single module may include another module. In the following description, the term “connection” refers to not only a physical connection but also a logical connection (such as exchanging of data, issuing of an instruction, and crass-reference between data items). The term “predetermined” as used herein means being determined prior to a process of interest, which not only means being determined before processing according to the exemplary embodiment begins but also being determined, even after the processing according to the exemplary embodiment begins, at any point in time preceding a process of interest in accordance with the condition/state at that point in time, or in accordance with the condition/state up to that point in time. If multiple “predetermined values” exist, each of these values may be different, or two or more of these values may be the same (which includes, of course, cases where all of these values are the same). Further, expressions that have the meaning of “if “A” holds, then “B” is performed” is used to mean that “it is determined if “A” holds, and then “3” is performed if it is determined that “A” holds”, unless it is not required to determine if “A” holds. When items are listed in the form “A, B, C”, for example, such a list is intended to be illustrative only unless otherwise specified, and includes cases where only one (e.g., only “A”) of the listed items is selected.

Furthermore, the term “system” or “apparatus” includes not only cases where a system or apparatus is made up of multiple components, such as computers, hardware components, or apparatuses that are connected to each other via a communication medium such as a network (including a one-to-one communication setup), but also cases where a system or apparatus is implemented by a single component such as a computer, a hardware component, or an apparatus. The terms “apparatus” and “system” are herein used synonymously. As a matter of course, the term “system” does not include what is merely a social “mechanism” (social system), which is a man-made arrangement of rules.

Further, for each process executed by each module or, if multiple processes are to be executed within a module, for each of the multiple processes, information of interest is read from a memory, and after execution of the corresponding process, the results of processing are written into the memory. Accordingly, a description about reading of information from a memory prior to a process, or writing of information into a memory after a process will be sometimes omitted. The term “memory” as used herein may include a hard disk, a random access memory (RAM), an external storage medium, a memory using a communication line, and a register in a central processing unit (CPU).

An information processing apparatus 100 according to the exemplary embodiment controls operation authority for an object. As illustrated in FIG. 1, the information processing apparatus 100 includes an operation authority receiving module 105, an operation authority management module 110, a configuration information receiving module 115, a configuration information management module 120, an operation instructing module 125, an operation executing module 130, an operation authority evaluating module 135, a user information management module 140, and a target object information management module 150.

The information processing apparatus 100 relates to a method for assessing operation authority for an object to be managed. In particular, the information processing apparatus 100 relates to an operation authority management method on which the status of an associated object is reflected. Although examples of objects to be managed include documents, such objects are not limited to documents but may include any information that can be managed. For example, an object to be managed may be a portion within a document. The following description is directed to an example in which such an object is a document. Examples of documents (also called files) include text data, numerical data, graphical data, image data, movie data, audio data, and combinations thereof that are subject to operations such as storage, editing, search, and retrieval and may be exchanged between systems users as discrete units, and also include data similar to those exemplified above. Specific examples of such data include documents created by document creation programs, images read by image reading devices (e.g., scanners), and Web pages. As far how a process is to be managed according to the exemplary embodiment, it suffices if it is possible to determine the progress of the process based on at least whether any document has been registered in association with the process. For example, it suffices if it is possible to manage, for each document, the approval status, disclosure status, or other status of the document.

First, before describing the exemplary embodiment, a description is given of its underlying idea or an information management system according to the exemplary embodiment. The description given below is intended for the purpose of facilitating the understanding of the exemplary embodiment.

A common method for setting access authority for an object to be managed is to set a bundle of information (access authority list) regarding who has what authority over the object. It is common to assign information such as a user, a user group, or a user role as the information about “who”, and assign a combination of primitive authorities such as the authorities to read, edit, and delete as the information about “what”. If such a method to be used to manage large quantities of objects, setting authority for each individual object makes the management process cumbersome and prone to setting errors.

A control method is known in which the absence of update authority for a given folder also disables updates to documents under the folders (documents included in the folder). Unfortunately, such a control method is limited to control of specific primitive authorities such as reference and update authorities based on a specific relation such as an inclusion relation. Accordingly, it is hitherto not possible to control authority for a given operation based on a relation between objects that do not have an inclusion relation. In other words, for a given object, it is not possible to set an authority that depends on the state of another object.

For example, it is hitherto not possible to set an operation authority that takes dependence between multiple objects into account, such as an operation authority that permits creation of an acceptance form if an application form has been created, or an operation authority that permits approval to be given once all of the front cover, the body, and the table of contents of a document are in place.

The information processing apparatus 100 is capable of setting the relation between multiple objects for which to set operation authority, and using the relation between objects to identify an object or group of objects associated with a specific object.

For example, the structure of a task process made up of multiple steps, and the type of document (object group) created in each individual step may be defined in association with each other. This makes it possible to express the relative relation between documents, such as specific documents (e.g., order forms) for the same project (an instance of task definition), or documents for the same step in the same project.

The relation between documents may not necessarily take the form of a task process structure. Other examples of such relations may include a relation between a copy source and a copy destination, a relation between documents stored in the same folder, and a relation between documents updated at substantially the same instant in time (including documents updated within a predetermined period of time of each other, e.g., one hour).

The information processing apparatus 100 makes it possible to set, as an authority to execute each individual operation, a rule that uses the state of a given object associated with a target object on which to execute the operation.

Examples of information that may be referenced as the state of a target object include a given attribute value associated with the object, and the existence status of the object (such as its presence/absence or the object's count).

For example, it is possible to set a rule such that an approve operation may be executed if all of the documents necessary for the same step are in place, or changes to a document being examined are disabled if an examination results report has been stored.

The operation authority receiving module 105 is connected with the operation authority management module 110. The operation authority receiving module 105 issues an operation authority storage instruction 107 to the operation authority management module 110. The operation authority receiving module 105 receives, for each operation on an object group, a condition that enables execution of the operation (operation executing condition).

Examples of an operation executing condition include the followings: (1) a condition determined by the relation between an object and another object within an object group in which a target object is included, (2) a condition determined by the state of an object to be created in a step within a task process, (3) a condition determined by the state of another step associated with a step or the state of an object to be created in the other step, (4) a condition determined by information related to a user who has made an operation request, and (5) a condition determined by a target object. The operation executing condition may include at least the condition (1) above. The operation executing condition may include a combination of multiple conditions. Examples of such combinations include logical operations such as logical OR and logical AND.

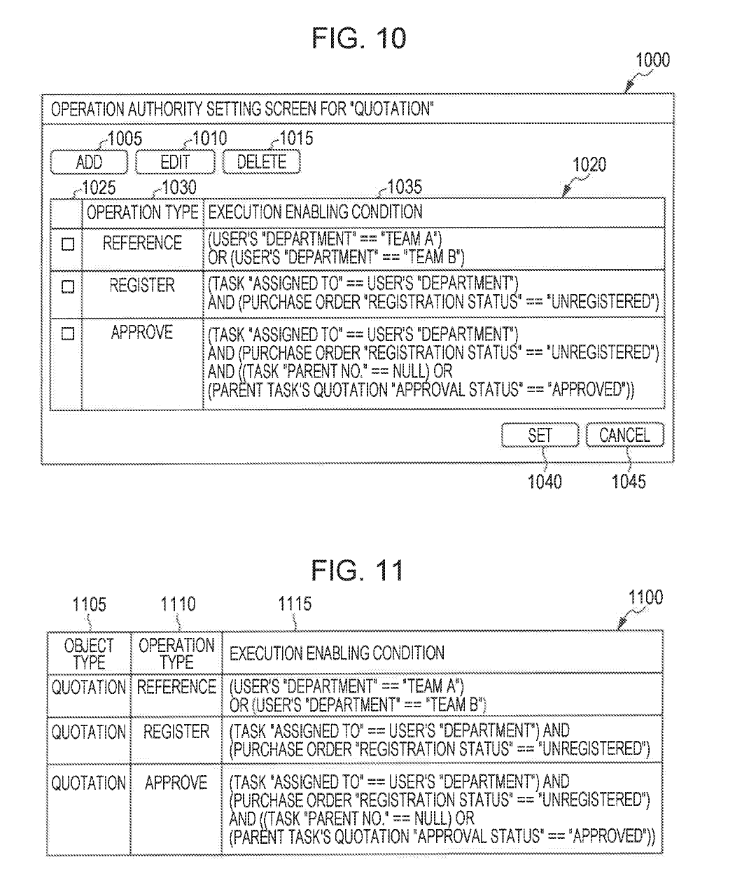

The function of the operation authority receiving module 105 and processing performed by the operation authority receiving module 105 will be described later with reference to FIG. 10.

The operation authority management module 110 is connected with the operation authority receiving module 105 and the operation authority evaluating module 135. The operation authority management module 110 saves operation authority information input from the operation authority receiving module 105, In other words, the operation authority management module 110 stores an operation executing condition associated with an object group in which a target object is included. The operation authority management module 110 passes the operation authority information in response to referencing of operation authority settings, which is indicated at 109, from the operation authority evaluating module 135.

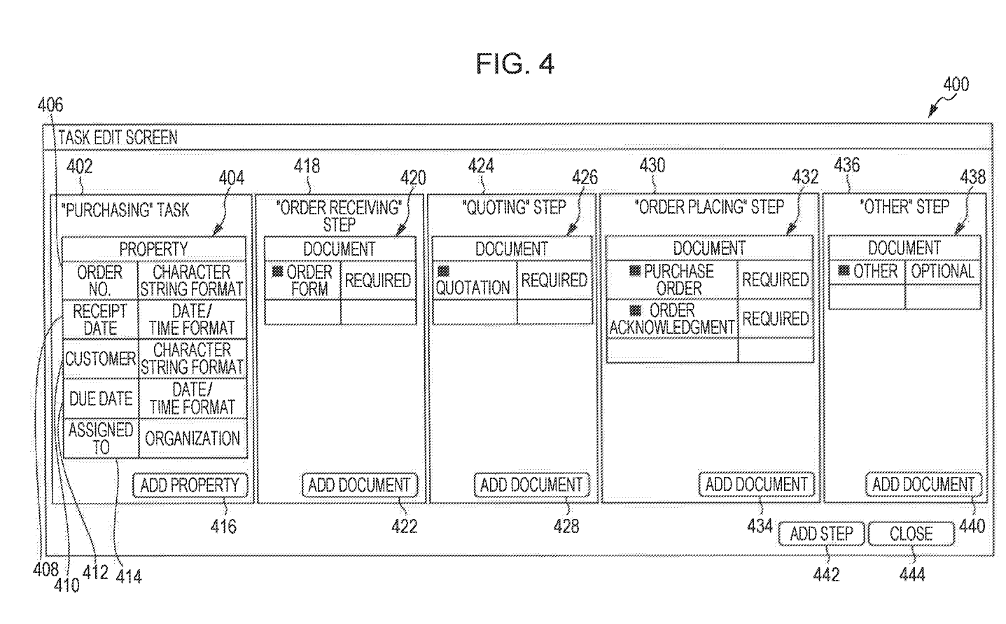

The configuration information receiving module 115 is connected with the configuration information management module 120. The configuration information receiving module 115 issues a configuration information storage instruction 17 to the configuration information management module 120. The configuration information receiving module 115 receives configuration information about an object group associated with a target object. Specifically, the configuration information receiving module 115 receives the relation between the structure of a task process and documents created in the course of (in each step within) the task process. The function of the configuration information receiving module 115 and processing performed by the configuration information receiving module 115 will be described later with reference to FIG. 4.

The configuration information management module 120 is connected with the configuration information receiving module 115 and the operation authority evaluating module 135. The configuration information management module 120 saves, in response to the configuration information storage instruction 117, configuration information about an object group associated with a target object. The configuration information management module 120 passes the configuration information in response to referencing of configuration information, which is indicated at 119, from the operation authority evaluating module 135.

The operation instructing module 125 is connected with the operation executing module 130. The operation Instructing module 125 receives an operation request for an object (a set of an operation to be executed and an object on which to execute the operation). Then, the operation instructing module 125 issues an operation instruction 127 according to the operation request to the operation executing module 130. The user instructs which operation is to be executed for what object, and the operation instructing module 125 receives this instruction. An example of such an instruction is an instruction to select, view (open), or delete a document.

The operation executing module 130 is connected with the operation instructing module 125 and the operation authority evaluating module 135. The operation executing module 130 issues an operation authority evaluation instruction 132 to the operation authority evaluating module 135. Specifically, the operation executing module 130 receives the operation instruction 127 from the operation instructing module 125, and issues an instruction (the operation authority evaluation instruction 132) instructing the operation authority evaluating module 135 to evaluate whether an operation of interest is executable. The operation executing module 130 executes the operation if the operation is determined to be executable.

The operation authority evaluating module 135 is connected with the operation authority management module 110, the configuration information management module 120, the operation executing module 130, the user information management module 140, and the target object information management module 150. The operation authority evaluating module 135 performs the referencing of operation authority settings 109 with respect to the operation authority management module 110, performs the referencing of information reference 119 with respect to the configuration information management module 120, performs referencing of user information, which is indicated at 137, with respect to the user information management module 140, and performs referencing of object information, which is indicated at 147, with respect to the target object information management module 150. In other words, the operation authority evaluating module 135 receives the operation authority evaluation instruction 132 from the operation executing module 130, and refers to the settings information about the corresponding operation authority in the operation authority management module 110. The operation authority evaluating module 135 acquires necessary information from the user information management module 140, the target object information management module 150, the configuration information management module 120, and other modules, and evaluates the presence/absence of operation authority in accordance with the operation authority settings.

The operation authority evaluating module 135 applies, to an object for which an operation request hats been made, an operation executing condition associated with an object group in which the object is included to thereby determine whether to permit or deny an operation on the object. The operation executing condition may include at least a condition determined by the relation between an object and another object within an object group in which the object is included.

The operation executing condition may include a condition related to the state of an object to be created in a step within a task process.

The operation executing condition may include a condition determined by the state of another step (A) related to a step or the state of an object to be created in the other step (A). Examples of “another step related to a step” in this case include a parent step if steps have a hierarchical structure. Examples of the “state of a step” include the presence/absence of the step.

The operation executing condition may include a condition related to information about a user who has made the operation request.

The operation executing condition may include a condition related to the object.

The operation authority evaluating module 135 performs the above-mentioned determination process upon receipt of the operation authority evaluation instruction 132 from the operation executing module 130, Each of the operation executing conditions mentioned above is acquired by performing, with respect to the operation authority management module 110, the referencing of operation authority settings 109 corresponding to the operation authority evaluation instruction 132. The referencing of operation authority settings 109 corresponding to the operation authority evaluation instruction 132 means extracting, based on a combination of an object group in which a target object is included and an operation, an operation executing condition corresponding to the combination. Then, information required for application of the operation executing condition to the object is acquired from at least one of the configuration information management module 120, the user information management module 140, and the target object information management module 150. At least configuration information from the configuration information management module 120 may be included in the information acquired at this time.

The user information management module 140 is connected with the operation authority evaluating module 135. The user information management module 140 manages user-related information, which represents information related to a user who has instructed an operation to be performed on an object. Specifically, the user information management module 140 manages information such as information related to each individual user, group information, and organization information. The operation authority evaluating module 135 passes the user-related information in response to the referencing of user information 137 made from the operation authority evaluating module 135.

The target object information management module 150 is connected with the operation authority evaluating module 135. The target object information management module 150 manages object-related information representing information related to an object that can be subject to an operation of interest. Examples of object-related information include document name, creator, date/time of creation, and document size. The target object information management module 150 passes the object-related information in response to the referencing of object information 147 made from the operation authority evaluating module 135.

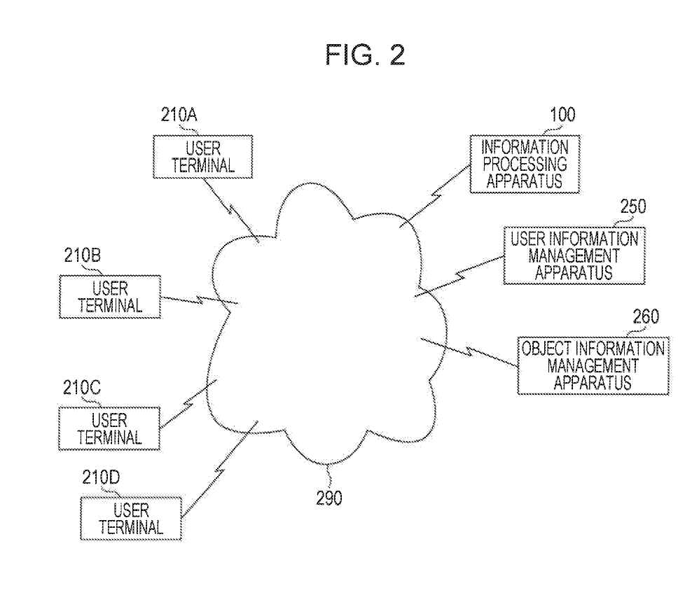

FIG. 2 illustrates an exemplary system configuration according to the exemplary embodiment.

The information processing apparatus 100, a user terminal 210A, a user terminal 210E, a user terminal 210C, a user terminal 210D, a user information management apparatus 250, and an object information management apparatus 260 are connected to each other via a communication line 290. The communication line 290 may be a wireless communication line, a wired communication line, or a combination thereof. For example, the communication line 290 may be the Internet or an intranet as a communication infrastructure. The functions provided by the information processing apparatus 100, the user information management apparatus 250, and the object information management apparatus 260 may be each implemented as a cloud service. Each of the user terminals 210A to 210D receives an operation to be performed on an object (an operation request made for the object) by the user, and requests the information processing apparatus 100 to execute the operation for the object. The information processing apparatus 100 determines, in accordance with an operation executing condition associated with an object group in which the object is included, whether it possible to execute the operation for the object. If the operation executing condition is satisfied, the information processing apparatus 100 executes the operation, and if the operation executing condition is not satisfied, the information processing apparatus 100 cancels the operation and issues a warning to that effect. The user information management apparatus 250 provides the user information management module 140 with user-related information. The object information management apparatus 260 provides the target object information management module 150 with object-related information. The information processing apparatus 100 may include the user information management apparatus 250 and the object information management apparatus 260. In other words, the user information management apparatus 250 may serve as the user information management module 140, and the object information management apparatus 260 may serve as the target object information management module 150.

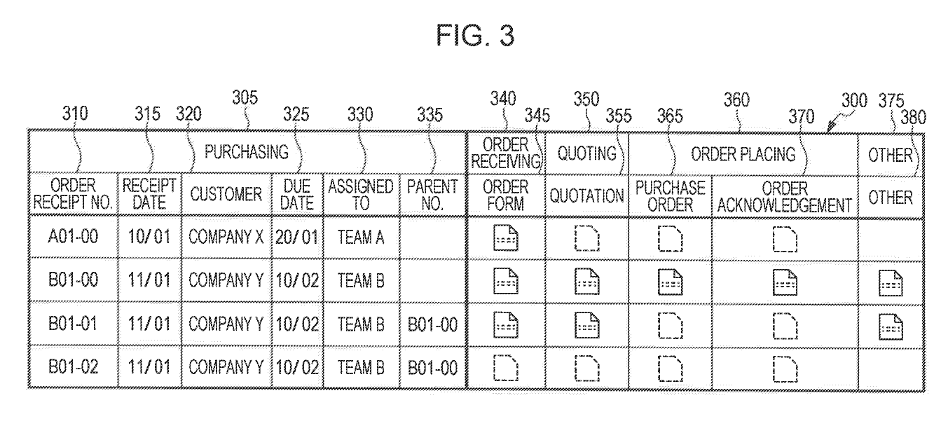

FIG. 3 illustrates exemplary information shown on a task list screen according to the exemplary embodiment.

A task list screen 300 shows information related to the structure of a task process stored in the configuration information management module 120. In other words, the task list screen 300 is a task list screen based on an application program that, based on the structure of a task process, enables checking of the registration status of documents generated in a task. The task list screen 300 provides at-a-glance view of the registration status of documents associated with a task. A given document may be referenced from the task list screen 300.

Copying or moving (drag-and-dropping (D&D)) a document to a given document cell on the task list screen 300 allows the document to be stored in association with a task process.

In response to a request for an operation such as the store operation mentioned above, a view operation (an operation of selecting a document icon within the task list screen 300 to open a document), or an edit operation for a document, it is determined in accordance with the operation executing condition whether to permit the operation for the document.

The task list screen 300 has a Purchasing field 305, an Order Receiving field 340, a Quoting field 350, an Order Placing field 360, and an Other field 375. The Purchasing field 305 has an Order Receipt No. field 310, a Received Date field 315, a Customer field 320, a Due Date field 325, an Assigned To field 330, and a Parent No, field 335. The Order Receiving field 340 has an Order Form field 345, the Quoting field 350 has a Quotation field 355, the Order Placing field 360 has a Purchase Order field 365 and an Order Acknowledgement field 370, and the Other field 375 has an Other field 380.

The Purchasing field 305 shows information necessary for a purchasing task. The Order Receipt No. field 310 shows an order receipt number. The Received Date field 315 shows the date of order receipt. The Customer field 320 shows a customer. The Due Date field 325 shows a due date. The Assigned To field 330 shows the entity to which the task is assigned. The Parent No. field 335 shows a parent number. The fields from the Order Receiving field 340 onward each show the presence/absence of a document stored for the task. For example, if a document icon appears in the Order Form field 345 of the Order Receiving field 340, this indicates that an order form associated with the “Order Receiving” step has been created and stored in the document management system. The Order Receiving field 340 shows a document necessary for the “Order Receiving” step. The Order Form field 345 shows the presence absence of an order form that has been stored. The Quoting field 350 shows a document necessary for the “Quoting” step. The Quotation field 355 shows the presence or absence of a quotation that has been stored. The Order Placing field 360 shows each document necessary for the “Order Placing” step. The Purchase Order field 365 shows the presence or absence of a purchase order that has been stored. The Order Acknowledgement field 370 shows the presence or absence of an order acknowledgement that has been stored. The Other field 375 and the Other field 380 each show information about another document.

For example, individual rows on the task list screen 300 show the following information. That is, the first row shows that for the task with the order receipt No.: “A01-00”, an order form associated with the order-receiving step has been stored. The second row shows that for the task with the order receipt No.: “B01-00”, an order form associated with the order-receiving step, a quotation associated with the quoting step, a purchase order and an order acknowledgement that are associated with the order-placing step, and another document have been stored. The third row shows that for the task with the order receipt No.: “B01-01”, an order form associated with the order receiving step, a quotation associated with the quoting step, and another document have been stored. The fourth row shows that for the task with the order receipt No.: “B01-02”, there is no stored document.

FIG. 4 illustrates exemplary information shown on a task edit screen according to the exemplary embodiment (in particular, the configuration information receiving module 115). FIG. 4 depicts an exemplary screen for setting the relation between the structure of a task process and documents created in the course of task performance. The content of a task edit screen 400 specifies the content of the task list screen 300 illustrated in FIG. 3. In other words, the content of the task edit screen 400 corresponds to the definition of a class in an object-oriented system.

The task edit screen 400 shows a “Purchasing” task property setting region 402, an “Order Receiving” step document setting region 418, a “Quoting” step document setting region 424, an “Order Placing” step document setting region 430, an “Other” step document setting region 436, an Add Step button 442, and a Close button 444. The “Purchasing” task property setting region 402 specifies the structure (such as attributes) of the “Purchasing” task process, and regions such as the “Order Receiving” step document setting region 418 show individual steps within the “Purchasing” task process, as shown from the left in the order in which these steps occur.

The “Purchasing” task property setting region 402 has a Property setting region 404, and an Add Property button 416. The Property setting region 404 includes the following regions showing individual attributes: an Order No. setting region 406, a Received Date setting region 408, a Customer setting region 410, a Due Date setting region 412, and an Assigned To setting region 414. The Order No. setting region 406 shows that the “Order No.” is in “Character String Format”, the Received Date setting region 408 shows that the “Received Date” is in “Date/Time Format”, the Customer setting region 410 shows that the “Customer” is in “Character String Format”, the Due Date setting region 412 shows that the “Due Date” is in “Date/Time Format”, and the Assigned To setting region 414 shows that the entity to which the task is “Assigned To” is “Organization”. Selecting the Add Property button 416 allows an attribute to be added for the “Purchasing” task.

Regions such as the “Order Receiving” step document setting region 418 and the “Quoting” step document setting region 424 show that the “Purchasing” task process includes an “Order Receiving” step, a “Quoting” step, an “Order Placing” step, and an “Other” step.

The “Order Receiving” step document setting region 418 includes a Document setting region 420, and an Add Document button 422. The “Quoting” step document setting region 424 includes a Document setting region 426, and an Add Document button 428. The “Order Placing” step document setting region 430 includes a Document setting region 432, and an Add Document button 434. The “Other” step document setting region 436 includes a Document setting region 438, and an Add Document button 440.

The Document setting region 420 shows that for the “Order Receiving” step, an “Order Form” is “Required”. The Document setting region 426 shows that for the “Quoting” step, a “Quotation” is “Required”. The Document setting region 432 shows that for the “Order Placing” step, a “Purchase Order” and an “Order Acknowledgement” are “Required”. The Document setting region 438 shows that for the “Other” step, an “Other” document is “Optional”. Selecting a button such as the Add Document button 422 allows a document to be added for the corresponding step.

Selecting the Add Step button 442 allows a step to be added for the “Purchasing” task process Selecting the Close button 444 causes the configuration information management module 120 to store, as the configuration information storage instruction 117, the relation between the structure of the “Purchasing” task process and documents created in the course of task performance within the task edit screen 400.

The “relation between the “Purchasing” task process and documents created in the course of task performance” actually generated based on the relation between the structure of the “Purchasing” task process and documents created in the course of task performance that is specified in FIG. 4 is represented as a document configuration information table 500. In other words, this corresponds to an instance generated based on a class in an object-oriented system. The document configuration information table 500 is stored in the configuration information management module 120.

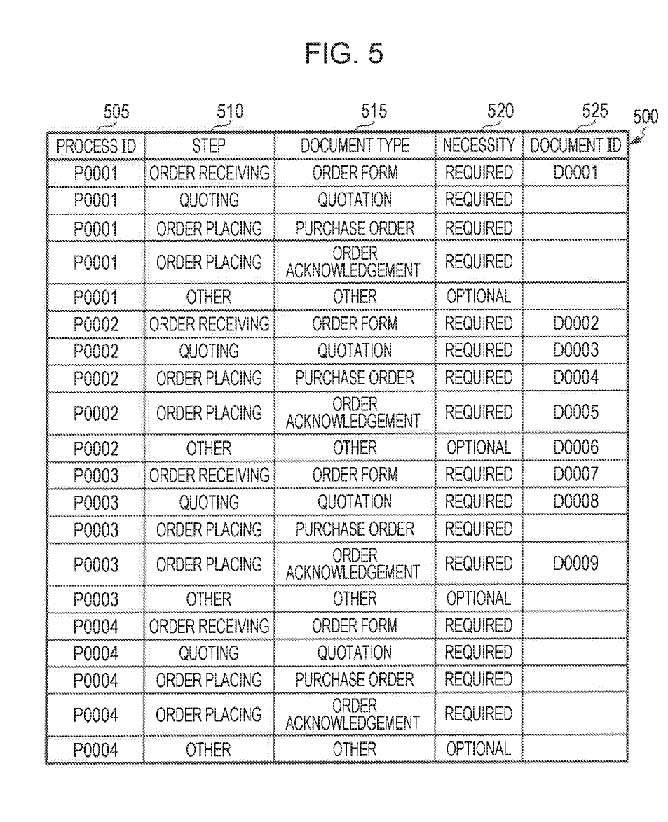

FIG. 5 illustrates an exemplary data structure of the document configuration information table 500. The document configuration information table 500 has a Process ID field 505, a Step field 510, a Document Type field 515, Necessity field 520, and a Document ID field 525. The Process ID field 505 stores information (process identification (ID)) for uniquely identifying a task process according to the exemplary embodiment. The Step field 510 stores a step constituting the task process. The Document Type field 515 stores the type of each document (e.g., a name such as “Order Form”) created in the step. The Necessity field 520 stores the degree of necessity of the document for completion of the step (e.g., required or optional). The Document ID field 525 stores information (document ID) for uniquely identifying a document according to the exemplary embodiment. In other words, if a document ID is stored in the Document ID field 525, this means that a document has been stored in the step, and if the Necessity field 520 is “Required” and all of documents corresponding to the step have been stored, this means that the step has been completed.

In accordance with information on the first to fifth rows of the document configuration information table 500 (process ID: P0001), information on the first row of the task list screen 300 (order receipt No.: A01-00) is shown. In accordance with information on the sixth to tenth rows of the document configuration information table 500 (process ID: P0002), information on the second row of the task list screen 300 (order receipt No.: B01-00) is shown. In accordance with information on the eleventh to fifteenth rows of the document configuration information table 500 (process ID: P0003), information on the third row of the task list screen 300 (order receipt No.: B01-01) is shown. In accordance with information on the sixteenth to twentieth rows of the document configuration information table 500 (process ID: P0004), information on the fourth row of the task list screen 300 (order receipt No.: B01-02) is shown.

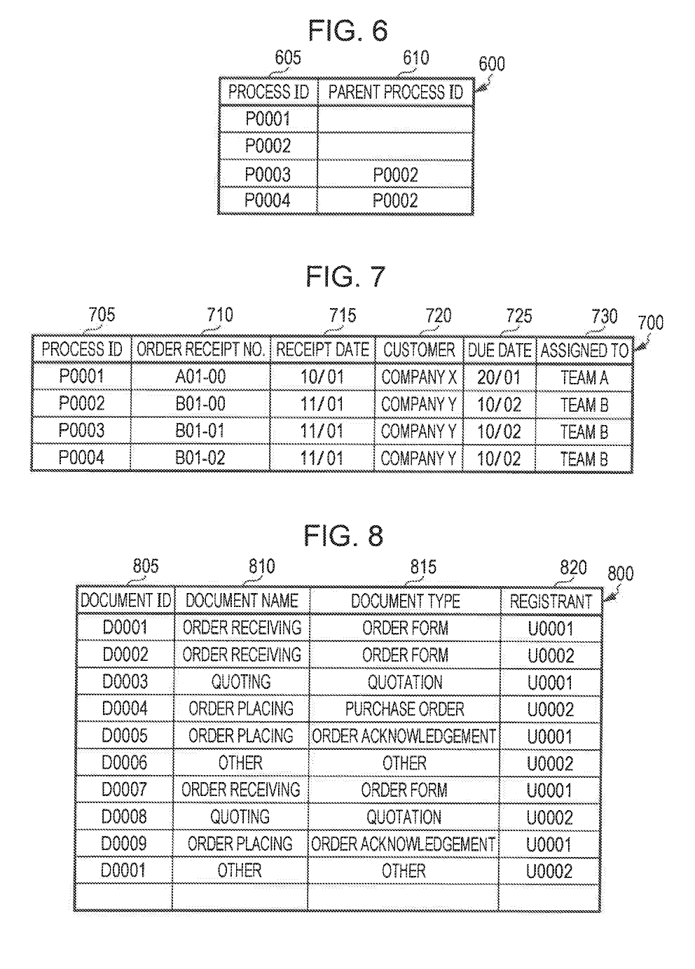

The relation between task processes is represented as a process configuration information table 600. The process configuration information table 600 is stored in the configuration information management module 120. FIG. 6 illustrates an exemplary data structure of the process configuration information table 600. The process configuration information table 600 includes a Process ID field 605, and a Parent Process ID field 610. The Process ID field 605 stores a process ID. The Parent Process ID field 610 stores a parent process ID. The presence of a parent process means that a process of interest has been generated based on the parent process. FIG. 6 illustrates that for processes with process ID “P0003” and “P0004”, a process with a process ID: “P0002” is the parent process. This parent process may be used to specify another step.

The “structure of the “Purchasing” task process” actually generated based on the relation between the structure of the “Purchasing” task process and documents created in the course of task performance that is specified in FIG. 4 is represented as a process information table 700. In other words, this corresponds to an instance generated based on a class in an object-oriented system. The process information table 700 is stored in the configuration information management module 120.

FIG. 7 illustrates an exemplary data structure of the process information table 700. The process information table 700 includes a Process ID field 705, an Order Receipt No. field 710, a Received Date field 715, a Customer field 720, a Due Date field 725, and an Assigned To field 730. The Process ID field 705 stores a process ID. The Order Receipt No. field 710 stores the order receipt number of the corresponding task process. The Received Date field 715 stores the date of receipt of the task process. The Customer field 720 stores the customer for the task process. The Due Date field 725 stores the due date for the task process. The Assigned To field 730 stores the organization (e.g., team) to which the task process is assigned.

The Purchasing field 305 on the task list screen 300 illustrated in FIG. 3 represents the process information table 700 and the process configuration information table 600.

FIG. 8 illustrates an exemplary data structure of a document information table 800. The document information table 800 is stored in the target object information management module 150. The document information table 800 includes a Document ID field 805, a Document Name field 810, a Document Type field 815, and a Registrant field 820. The Document ID field 805 stores a document ID. The Document Name field 810 stores a document name. The Document Type field 815 stores the type of a document of interest. The Registrant field 820 stores the user who has registered the document. In response to an operation made on the task edit screen 400 illustrated in FIG. 4 to store a document, the registrant is stored into the Registrant field 820.

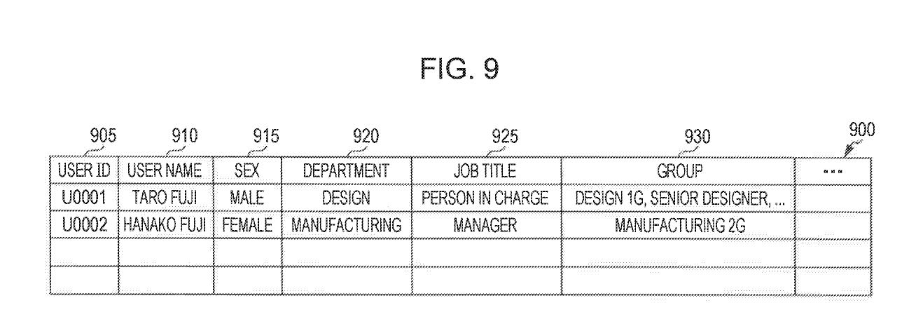

FIG. 9 illustrates an exemplary data structure of a user information table 900. The user information table 900 is stored in the user information management module 140. The user information table 900 includes a User ID field 905, a User Name field 910, a Sex field 915, a Department field 920, a Job Title field 925, and a Group field 930. The User ID field 905 stores information (user ID) for uniquely identifying a user according to the exemplary embodiment. The User Name field 910 stores the name of the user. The Sex field 9:15 stores the sex of the user. The Department field 920 stores the department to which the user belongs. The Job Title field 925 stores the job title of the user. The Group field 930 stores the group to which the user belongs.

FIG. 10 illustrates exemplary information shown on a document-group operation authority setting screen according to the exemplary embodiment (in particular, the operation authority receiving module 105).

A document-group operation authority setting screen 1000 shows an Add button 1005, an Edit button 1010, a Delete button 1015, an operation authority setting region 1020, a Set button 1040, and a Cancel button 1045.

The operation authority setting region 1020 includes a check field 1025, an Operation Type field 1030, and an Execution Enabling Condition field 1035. The check field 1025 shows a check field. The Operation Type field 1030 shows an operation type. The Execution Enabling Condition field 1035 shows an execution enabling condition (operation executing condition).

Selecting the Add button 1005 allows an operation executing condition to be added to the operation authority setting region 1020. Selecting the Edit button 1010 allows a row checked in the check field 1025 to be edited. Selecting the Delete button 1015 allows a row checked in the check field 1025 to be deleted.

The document-group operation authority setting screen 1000 is a screen for specifying an operation executing condition for a “Quotation” representing an object group.

The first row of the operation authority setting region 1020 shows that to execute the operation type: reference, the following condition needs to be satisfied: “(user's “Department”==“Team A”) OR (user's “Department”==“Team B”)”, The second row of the operation authority setting region 1020 shows that to execute the operation type: register, the following condition needs to be satisfied: “(task “Assigned To”==user's “Department”) AND (purchase order “Registration Status”==“Unregistered”)”. The third row of the operation authority setting region 1020 shows that to execute the operation type: approve, the following condition needs to be satisfied: “(task “Assigned To”==user's “Department”) AND (purchase order “Registration Status”==“Unregistered”) AND ((task “Parent Number”==null) OR (patent task's quotation “Approval Status”==“Approved”))”.

In particular, the second and third rows each include a condition specified by the relation between a “Quotation”, which is a target object, and another document. In other words, the second row shows that a register operation for a “Quotation”, which is a target object, is enabled if the “Assigned To” attribute of a task including the “Quotation” and the “Department” attribute of the user attempting to use the “Quotation” are equal, and if the “Registration Status” of a “Purchase Order” document for the task process is “Unregistered”. The third row shows that an approve operation is enabled if the “Assigned To” attribute of a task including a “Quotation”, which is a target object, and the “Department” attribute of the user attempting to use the “Quotation” are equal, if the “Registration Status” of a “Purchase Order” document for the task process is “Unregistered”, and if no parent task exists or the “Approval Status” of a “Quotation” document for a parent task is “Approved”.

An example of a condition related to the state of an object to be created in a step within a task process is “Purchase Order “Registration Status”==“Unregistered””, which is related to the state f a purchase order in a task process including a quotation.

An example of a condition determined by the state of another step associated with a step of interest, or an example of a condition determined by the state of an object to be created in the other step is “parent task's quotation “Approval Status”==“Approved””, which is related to the state of a quotation for a parent task (including the state of a quoting step).

An example of a condition related to a user who has made an operation request is “task “Assigned To”==user's “Department””, which is related to the department to which the user belongs.

An example of an object-related condition is “task “Assigned To”==user's “Department””, which is related to the entity to which the quotation is assigned.

The operation executing condition generated by using the document-group operation authority setting screen 1000 illustrated in FIG. 10 is stored as an operation authority table 1100.

FIG. 11 illustrates an exemplary data structure of the operation, authority table 1100. The operation authority table 1100 is stored in the operation authority management module 110. The operation authority table 1100 in this case represents a state when the Set button 1040 has been selected on the document-group operation authority setting screen 1000 illustrated in FIG. 10.

The operation authority table 1100 includes an Object Type field 1105, an Operation Type field 1110, and an Execution Enabling Condition field 1115. The Object Type field 1105 stores an object type. The Operation Type field 1110 stores the type of an operation to be performed on an object corresponding to the object type. The Execution Enabling Condition field 1115 stores a condition for executing the operation corresponding to the operation type for the object.

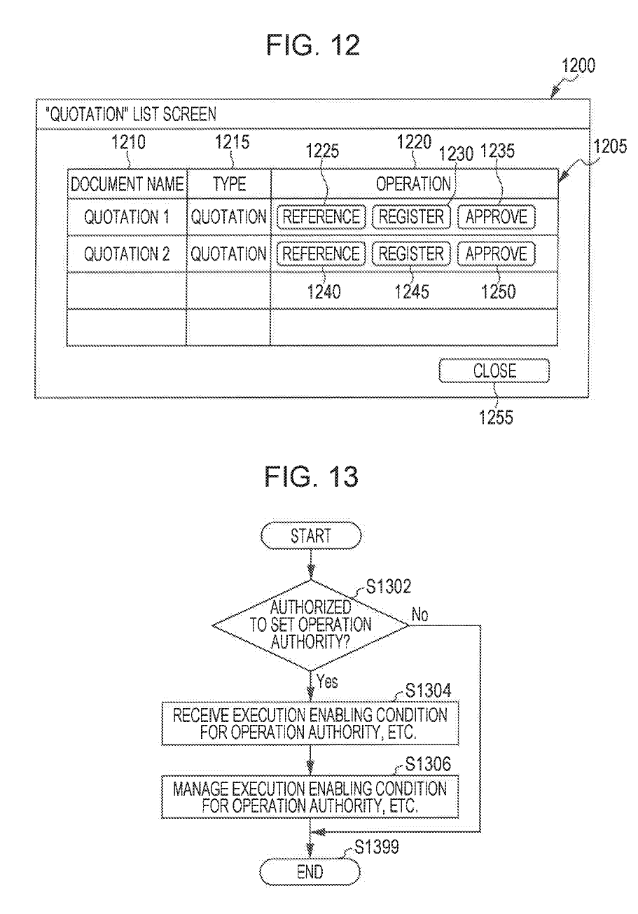

FIG. 12 illustrates exemplary information shown on a “Quotation” list screen 1200 according to the exemplary embodiment. The “Quotation” list screen 1200 is a screen used to perform operations on a quotation, including reference, register, and approve operations. The “Quotation” list screen 1200 shows an operation instructing region 1205, and a Close button 1255. The operation instructing region 1205 includes a Document Name field 1210, a Type field 1215, and an Operation field 1220. The Document Name field 1210 stores the name of a document of interest. The Type field 1215 shows the type of the document (an example of “a document group in which the document is included”). The Operation field 1220 shows each operation for the document. In the first row of the operation instructing region 1205, a Reference button 1225, a Register button 1230, and an Approve button 1235 are shown in a selectable manner for “Quotation 1”. In the second row of the operation instructing region 1205, a Reference button 1240, a Register button 1245, and an Approve button 1250 are shown in a selectable manner for “Quotation 2”.

FIG. 13 is a flowchart of an exemplary process according to the exemplary embodiment.

At step S1302, the operation authority receiving module 105 determines whether the user is authorized to set operation authority. If the determination is affirmative, the process proceeds to step S1304. Otherwise, the process is ended (step S1399). In other words, the operation authority receiving module 105 determines whether the user is an administrator authorized to generate, edit, delete, or perform other operations on the operation executing condition. For example, this may be determined by using the user ID or other information about the user.

At step S1304, the operation authority receiving module 105 receives information such as an execution enabling condition for the operation authority. Specifically, such information is received by use of the document-group operation authority setting screen 1000 illustrated in FIG. 10.

At step S1306, the operation authority management module 110 manages information such as the execution enabling condition for the operation authority. Specifically, the operation authority table 1100 illustrated in FIG. 11 is stored.

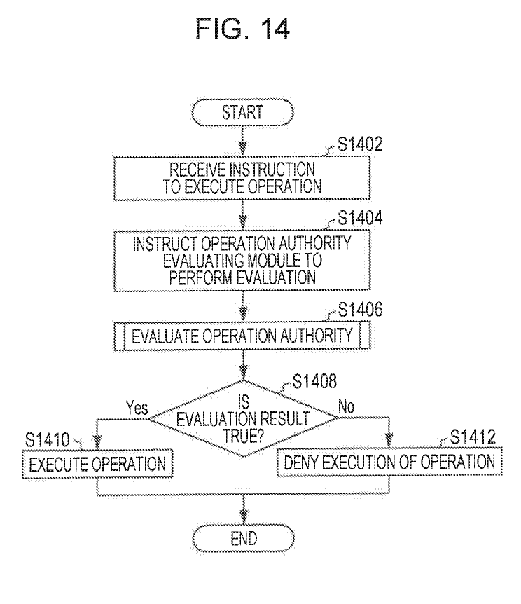

FIG. 14 is a flowchart of an exemplary process according to the exemplary embodiment.

At step S1402, the operation instructing module 125 receives an instruction to execute an operation. Specifically, this instruction is received by use of the “Quotation” list screen 1200 illustrated in FIG. 12.

At step S1404, the operation executing module 130 instructs the operation authority evaluating module 135 to perform an evaluation.

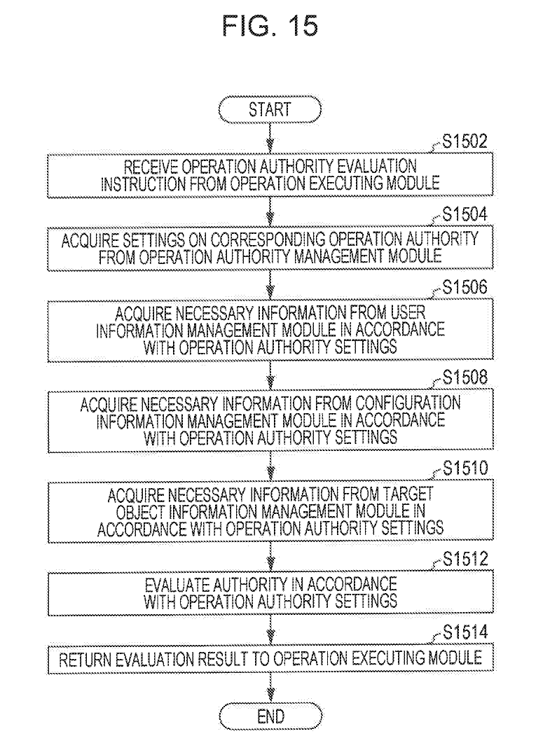

At step S1406, the operation authority evaluating module 135 performs an operation authority evaluation. Step S1406 will be described in detail later with reference to the flowchart illustrated in FIG. 15.

At step S1408, the operation authority evaluating module 135 determines whether the evaluation result is true. If the evaluation result is true (if the operation on the object is to be permitted), the process proceeds to step S1410. Otherwise, the process proceeds to step S1412.

At step S1410, the operation executing module 130 executes the operation.

At step S1412, the operation executing module 130 denies execution of the operation.

FIG. 15 is a flowchart illustrating an exemplary process according to the exemplary embodiment (in particular, the operation authority evaluating module 135).

At step S1502, an operation authority evaluation instruction is received from the operation executing module 130.

At step S1504, the settings on the corresponding operation authority are acquired from the operation authority management module 110. Specifically, the operation executing condition corresponding to the type of a target object is acquired from the operation authority table 1100.

At step S1506, in accordance with the operation authority settings, necessary information is acquired from the user information management module 140. Specifically, information necessary for evaluating the operation executing condition is extracted from the user information table 900 within the user information management module 140.

At step S1508, in accordance with the operation authority settings, necessary information is acquired from the configuration information management module 120. Specifically, information necessary for evaluating the operation executing condition is extracted from the document configuration information table 500, the process configuration information table 600, and the process information table 700 within the configuration information management module 120.

At step S1510, in accordance with the operation authority settings, necessary information is acquired from the target object information management module 150. Specifically, information necessary for evaluating the operation executing condition is extracted from the document information table 800 within the target object information management module 150.

At step S1512, authority is evaluated in accordance with the operation authority settings. Specifically, the pieces of information acquired from steps S1506 to S1510 are applied to the operation executing condition acquired in step S1504 to determine whether the operation executing condition is satisfied.

At step S1514, the evaluation result is returned to the operation authority evaluating module 135.

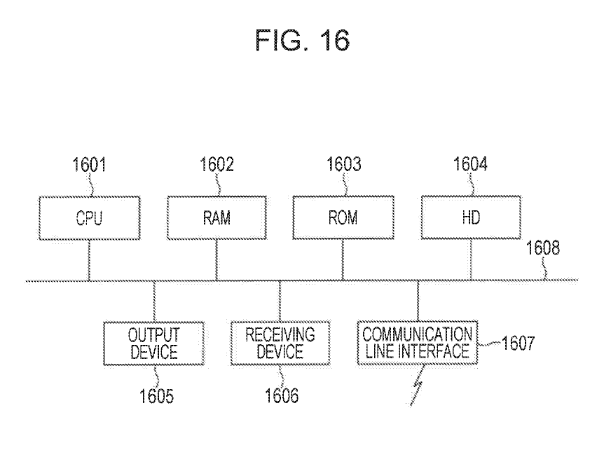

The hardware configuration of a computer on which the program according to the exemplary embodiment is executed is that of a general computer as illustrated in FIG. 16, specifically, for example, a personal computer, or a computer that can serve as a server. That is, as a specific example, a CPU 1601 is used as a processing unit (arithmetic unit), and a RAM 1602, a ROM 1603, and an HD 1604 are used as memories. For example, a hard disk or a solid state drive (SSD) may be used as the HD 1604. The computer includes the following components: the CPU 1601 that executes a program for implementing modules such as the operation authority receiving module 105, the operation authority management module 110, the configuration information receiving module 115, the configuration information management module 120, the operation instructing module 125, the operation executing module 130, the operation authority evaluating module 135, the user information management module 140, and the target object information management module 150; the RAM 1602 that stores the program or other data; the ROM 1603 in which a program for booting the computer or other data is stored; the HD 1604, which is an auxiliary memory (which may be, for example, a flash memory) that functions as a memory in each of the operation authority management module 110, the configuration information management module 120, the user information management module 140, and the target object information management module 150; a receiving device 1606 that receives data based on user's operations made on a keyboard, a mouse, a touch screen, a microphone, or other devices; an output device 1605 such as a CRT, a liquid crystal display, or a loudspeaker; a communication line interface 1607 for establishing a connection with a communication network, such as a network interface card; and a bus 1608 that interconnects the above-mentioned components to exchange data, Multiple such computers may be connected to each another via a network.

For features based on a computer program in the exemplary embodiment, a system having the above-mentioned hardware configuration is caused to read the computer program as software, and the exemplary embodiment is implemented by cooperation of the software and hardware resources.

The hardware configuration depicted in FIG. 16 is only illustrative of one exemplary configuration. The exemplary embodiment is not limited to the hardware configuration illustrated in FIG. 16 but may employ any configuration that enables execution of the modules described in the exemplary embodiment. For example, some modules may be implemented by dedicated hardware (such as an application-specific integrated circuit (ASIC)), or some modules may be located w′thin an external system and connected via a communication line. Further, multiple systems illustrated in FIG. 16 may be connected to each another by a communication line so as to operate in cooperation with each other. The above-mentioned configuration may be incorporated in, other than personal computers, in particular, portable information communication devices (including cellular phones, smart phones, mobile devices, wearable computers, and other devices), information home appliances, robots, copiers, facsimiles, scanners, printers, and multifunction machines (image processing apparatuses having two or more of, for example, scanner, printer, copier, and facsimile functions), for example.

The expressions such as “to show” or “shown” as used with reference to the above-mentioned exemplary embodiment may include, other than displaying of information on a display device such as a liquid crystal display, outputting of information as a three-dimensional (3D) image, and may further include using of combinations of, for example, printing on a printing device such as a printer, output of sound to an audio output device such as a loudspeaker, and a vibration.

The program described herein may be provided in the form of being stored on a recording medium, or the program may be provided by means of communication. In that case, for example, the above-mentioned program may be understood as an exemplary embodiment of the invention related to a “computer readable recording medium storing a program”.

The “computer readable recording medium storing a program” refers to a computer readable recording medium on which a program is stored and which is used for purposes such as installing, executing, and distributing the program.

Examples of the recording medium include digital versatile discs (DVDs), such as “DVD-R, DVD-RW, DVD-RAM, or other types of DVDs”, which are standards developed by the DVD Forum, and “DVD-FR, DVD+RW, or other types of DVDs”, which are standards developed by the DVD+RW alliance, compact discs (CDs) such as read-only memory (CD-ROM), CD-Recordable (CD-R), and CD-Rewritable (CD-RW) discs, Blu-ray (registered trademark) discs, magneto-optical discs (MOs), flexible disks (FDs), magnetic tapes, hard disks, read-only memories (ROMs), Electrically Erasable Programmable Read-only Memories (EEPROMs (registered trademark)), flash memories, random access memories (RAMS), and secure digital (SD) memory cards.

The above-mentioned program or a portion thereof may be stored on the above-mentioned recording medium for purposes such as saving and distribution. Alternatively, the program may be transmitted by communication, for example, via a transmission medium such as a wired network or a wireless communication network which is used for a local area network (LAN), a metropolitan area network (MAN), a wide area network (WAN), the Internet, an intranet, an extranet, or other networks, or a combination thereof, or may be carried on a carrier wave.

Further, the program mentioned above may constitute a portion or the entirety of another program, or may be stored on a recording medium together with a different program. Alternatively, the program may be stored separately on multiple recording media. Furthermore, the program may be stored in any form, such as compressed or encrypted, as long as the program may be restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives an operation request for an object; and
a permitting unit that applies an operation executing condition to the object for which the operation request has been made to determine whether to permit an operation on the object, the operation executing condition including at least a condition determined by a relation between an object and another object within an object group in which the object is included.

2. The information processing apparatus according to claim 1,
wherein the operation executing condition comprises a condition determined by an object to be created in a step within a task process.

3. The information processing apparatus according to claim 2,
wherein the operation executing condition comprises a condition determined by a state of another step associated with the step or a state of an object to be created in the other step.

4. The information processing apparatus according to claim 1,
wherein the operation executing condition comprises a condition determined by information related to a user who has made the operation request.

5. The information processing apparatus according to claim 1,
wherein the operation executing condition comprises a condition related to the object.

6. A non-transitory computer readable medium storing a program causing a computer to execute a process for processing information, the process comprising:
receiving an operation request for an object; and
applying an operation executing condition to the object for which the operation request has been made to determine whether to permit an operation on the object, the operation executing condition including at least a condition determined by a relation between an object and another object within an object group in which the object is included.
